(19) United States
(12) Patent Application Publication
(10) Pub. No.: US 2010/0116799 A1
(43) Pub. Date: May 13, 2010

(54) ROLLER MACHINING METHOD AND ROLLER MACHINING APPARATUS

(76) Inventors: Kazuyoshi Momoi, Osaka (JP); Yoshifumi Taguchi, Osaka (JP); Takuhiro Nishimura, Osaka (JP); Takashi Nonoshita, Osaka (JP); Hitoshi Katayama, Osaka (JP)

Correspondence Address: MCDERMOTT WILL & EMERY LLP, 600 13TH STREET, NW, WASHINGTON, DC, 20005-3096, US

(21) Appl. No.: 12/595,327

(22) PCT Filed: Oct. 28, 2008
(86) PCT No.: PCT/JP2008/003078

§ 371 Date: Oct. 9, 2009

(30) Foreign Application Priority Data
Nov. 5, 2007 (JP) 2007-287743
Nov. 5, 2007 (JP) 2007-287744

(51) Int. Cl. B23K 26/38

(52) U.S. Cl. 219/121.71; 219/121.7

(57) ABSTRACT

A laser beam 21 outputted by a laser oscillator 3 is collected by a machining head 4, so that the surface of a roller 2 is irradiated with the laser beam. An encoder 5c outputs a signal in accordance with a rotational position of the roller 2. A control portion 24 controls the laser oscillator 3 to irradiate the roller 2 at the same spots on the surface with the laser beam 21 per rotation of the roller 2, the irradiation being repeated a plurality of times, thereby forming recesses in the surface of the roller.

### TECHNICAL FIELD

The present invention relates to roller machining methods and roller machining apparatuses. More specifically, the invention relates to a method and apparatus for machining a roller so that, for example, protrusions having a predetermined shape can be formed on a surface, the roller being intended to form protrusions having a predetermined shape on the surface of metal foil, which is a material for battery current collectors.

### BACKGROUND ART

In recent years, with the spread of portable apparatuses, such as personal computers and cell phones, the demand for batteries as their power supplies has increased. Batteries used in applications as above are required to have high-energy density and superior cycle characteristics.

In order to meet such demand, new technologies have been developed for obtaining high-capacity active materials for positive and negative electrodes, respectively. For example, alloys or oxides containing silicon or tin, which achieve high capacity, are used as negative electrode active materials with a view to meeting the demand. The problem here is deformation of a negative electrode plate. Specifically, lithium ions are repeatedly inserted and released during charge and discharge, so that the active material repeats large expansions and contractions. Accordingly, the electrode plate is significantly distorted and undulated. As a result, the electrode plate is spaced apart from a separator, resulting in non-uniform charge/discharge reaction, hence deterioration of charge/discharge cycle characteristics.

To address such problems, for example, Patent Document 1 proposes a technique for preventing deformation of the current collector. Here, the surface of the current collector is rendered irregular, and a thin film made of an active material is deposited over protrusions on the surface of the current collector. At this time, cavities are formed so as to broaden toward the surface of the current collector between lumps of the active material deposited over the protrusions.

The present inventors eagerly conducted examinations on the above proposal, and consequently arrived at the conclusion that a thin film made of an active material as disclosed in Patent Document 1 can be formed by arranging a number of minute protrusions, ideally each having a rhombic vertex, at regular intervals on the surface of the current collector. In a conceivable method for forming such protrusions on the surface of the current collector, recesses shaped to accord with the protrusions are formed at regular intervals in the surface of a pressing tool, such as a roller, to press the current collector. In view of, for example, machining speed, it is preferable that formation of such recesses in the roller surface be performed by laser machining.

An example of the conventional art relevant in terms of the above points is a method for producing a planographic printing plate support disclosed in Patent Document 2. Here, recesses 61 are formed by laser irradiation onto the surface of a transfer roller for pressing an aluminum plate used as a planographic printing plate support, as shown in FIGS. 10A and 10B. At this time, dissolved components are projected and used to form protrusions 62.

Also, Patent Document 3 shown below proposes a technique for preventing the current collector from wrinkling at the time of charge/discharge, thereby reducing volume change. Concretely, a thin film electrode is provided, including a current collector made of metal not alloyable with lithium and a thin film formed on the current collector and including elements alloyable with lithium, the current collector having recesses and protrusions and also having an effective thickness of 15 μm to 300 μm.

Also, Patent Document 4 discloses a method in which a plurality of discrete laser-engraved cells 63 are formed in the surface of a liquid transfer cylindrical article made of ceramic or metal carbide, each cell being formed using two or more consecutive discrete pulses.

In addition, Patent Document 5 discloses a method in which cells are formed in the surface of a liquid transfer article made of a ceramic material by sequential irradiation with each of two separate laser beams.

Also, Patent Document 6 discloses a method in which a roller surface is irradiated with pulsed laser beams to melt or evaporate irradiation spots on the roller surface, thereby forming irregular patterns on the roller surface. Here, the irregular patterns are formed by scanning the irradiation spots with a polygon mirror.

In addition, Patent Document 7 discloses a method in which a cylindrical resin printing material is irradiated on its cured photosensitive resin-covered surface with laser beams with an average output of 0.01 to 5 W, an energy amount of 10 to 50 J per pulse, and a beam diameter of 0.4 to 15 μm, thereby forming minute recessed patterns with a width of 0.4 to 20 μm and a depth of 1 to 100 μm.

Patent Document 1: Japanese Laid-Open Patent Publication No. 2002-313319

Patent Document 2: Japanese Patent No. 3010403 (Japanese Laid-Open Patent Publication No. Hei 6-171261)

Patent Document 3: Japanese Laid-Open Patent Publication No. 2005-38797

Patent Document 4: Japanese Patent No. 2727264 (Japanese Laid-Open Patent Publication No. Hei 4-231186)

Patent Document 5: Japanese Laid-Open Patent Publication No. 2001-191185

Patent Document 6: Japanese Laid-Open Patent Publication No. 2004-351443

Patent Document 7: Japanese Laid-Open Patent Publication No. 2006-248191

### DISCLOSURE OF THE INVENTION

### Problem to be Solved by the Invention

Here, the roller is used to press a metallic member so as to form protrusions on its surface, and therefore needs to be made of an extremely hard metal material. However, in the case of performing laser machining on the roller made of such a material to form recesses in its surface, the formed recesses have a shape deviating from a desired shape (e.g., rhombus) toward the bottom as viewed in plane, due to, for example, thermal expansion through laser beam irradiation.

The present invention has been made in view of the problem as mentioned above, and a first objective thereof is to provide a roller machining method and a roller machining apparatus that are capable of eliminating any adverse thermal effect due to laser beam irradiation as much as possible, thereby forming minute recesses having a desired shape in the surface of a roller.

Also, to solve the above problem, it is necessary to suppress temperature rise during formation of recesses by laser machining. To achieve this, laser beam irradiation, which is required to obtain recesses of a desired depth, is effectively performed a plurality of times at predetermined intervals. The present invention is directed to a method and apparatus for practically applying such a technical idea.

However, for example, to form protrusions as described above on metal foil, which is a material for the battery current collector, if the roller, which is a machining tool for such formation, has recesses to be formed in its surface, the recesses are required to be on the order of μm, and arranged at pitches of the same order. Furthermore, to complete such machining within a relatively short period of time, it is necessary to intermittently irradiate the surface of the roller being rotated with a laser beam at times corresponding to the pitches, such that the roller surface is irradiated at the same spots with a laser beam per rotation of the roller, and such irradiation is repeated a plurality of times.

However, there is a technical difficulty as described below in irradiating the same spots on the roller surface with a laser beam with accuracy of the order of μm while rotating the roller.

Specifically, a rotary encoder is normally used to detect a rotational position of the roller. To form recesses in the roller surface at predetermined pitches, the procedure is repeated of counting output signals from the rotary encoder and irradiating the roller surface with a laser beam each time the number of counted signals reaches a number corresponding to the pitch.

However, when the number of signals outputted by the rotary encoder per rotation of the roller is not divisible by the number of signals corresponding to the pitch, it is not possible to irradiate the same spots on the roller surface with a laser beam per rotation of the roller. The reason for this will be described below.

A case as shown in FIG. 12 is considered where n recesses H(1) to H(n) are formed at predetermined pitches LP in a circumferential direction of the surface of a roller 50. In this case, if the number of signals outputted by the rotary encoder per rotation of the roller 50 is not divisible by the number of signals corresponding to the pitch LP, an error (E1) occurs in a laser beam irradiation point per rotation of the roller by the number of signals corresponding to a remainder left over. Accordingly, when irradiation with the laser beam 53 is attempted so as to overlap with a concavity (recess H(1)) formed by the last laser beam irradiation, a concavity (recess H(n+1)) is formed at a point deviating by length E1. If such an attempt is performed a plurality of times, the laser beam irradiation point deviates upon each attempt. Accordingly, when the error (E1) is greater than a certain level, it is not possible to form recesses in a desired shape by irradiating the same spots on the roller surface with a laser beam a plurality of times while rotating the roller.

Specifically, in the above method, the pitch LP allowing formation of the recesses in the surface of the roller 50 is limited by the number of signals outputted by the rotary encoder per rotation. Accordingly, in the case where recesses are formed in the roller surface at various pitches, it is necessary to prepare a plurality of rotary encoders outputting different numbers of signals per rotation, and replace them with each other in accordance with a desired pitch to perform laser machining on the roller. However, in the case of an apparatus requiring precise machining, a significant period of time might be taken to make adjustments especially when a measurement device, such as an encoder, is replaced, and therefore it might be practically impossible to take the approach as described above.

The present invention has been made in view of the problem as mentioned above, and a second objective thereof is to provide a roller machining method and a roller machining apparatus that allow fine adjustments of pitches at which to form recesses when a roller being rotated is irradiated at the same spots on the roller surface with a laser beam per rotation of the roller, the irradiation being performed a plurality of times, thereby forming the recesses at predetermined pitches.

### Means for Solving the Problem

To attain the objectives mentioned above, the present invention is directed to a roller machining method for forming a plurality of recesses in a surface of a roller made of a metal material, the method comprising the steps of:

(a) rotating the roller;

(b) detecting a position of the roller being rotated; and

(c) irradiating the roller at the same spots on the surface with a laser beam per rotation of the roller, the irradiation being repeated a plurality of times, thereby forming the recesses in the surface of the roller.

In a preferred embodiment of the present invention, the method further comprises the steps of:

(d) generating a pulse signal per rotation of the roller by a predetermined angle based on the detected absolute position of the roller; and

(e) setting the number of pulse signals to be generated per rotation of the roller based on pitches at which to form the recesses in the surface of the roller, wherein, in step (c), the number of generated pulse signals is counted, and the surface of the roller is irradiated with the laser beam each time the number reaches a number corresponding to the pitch.

In a more preferred embodiment of the present invention, the number of pulse signals set in step (e) is either divisible by the number of pulse signals corresponding to the pitch or indivisible by the number, leaving a remainder equal to or less than a predetermined value.

In a more preferred embodiment of the present invention, the method further comprises the step of: (f) preselecting and storing a candidate for the number of pulse signals to be set in step (e) in accordance with a diameter of the roller.

Also, in a more preferred embodiment of the present invention, step c includes the steps of:

(g) shaping an outline of the laser beam to be similar in shape to the recesses; and

(h) condensing the laser beam having the shaped outline, thereby forming an image on the surface of the roller.

Also, the present invention is directed to a roller machining apparatus for forming a plurality of recesses in a surface of a roller made of a metal material, the apparatus comprising:

a laser oscillator for outputting a laser beam;

a machining head having a function of collecting the laser beam outputted by the laser oscillator, such that the surface of the roller is irradiated at a predetermined position with the laser beam;

roller rotation means for rotating the roller;

rotational position detection means for outputting a signal in accordance with a position of the roller being rotated; and

control means for controlling the laser oscillator based on the signal outputted by the rotational position detection means, such that the surface of the roller is irradiated at the same spots with the laser beam per rotation of the roller, the irradiation being performed a plurality of times, thereby forming the recesses in the surface of the roller.

In a predetermined embodiment of the present invention, the apparatus further comprises:

pulse signal generation means for generating a pulse signal per rotation of the roller by a predetermined angle based on the detected absolute position of the roller; and

pulse number setting means for setting the number of pulse signals to be generated per rotation of the roller based on pitches at which to form the recesses in the surface of the roller, wherein,

the control means controls the laser oscillator to count the number of pulse signals, and irradiate the surface of the roller with the laser beam each time the number reaches a number corresponding to the pitch.

In another preferred embodiment of the present invention, the material of the roller is cemented carbide, powder metallurgy high-speed steel, or tempered steel.

In another preferred embodiment of the present invention, the laser beam has a wavelength of 266 nm to 600 nm.

### EFFECT OF THE INVENTION

According to the present invention, it is possible to form minute recesses of a desired shape in a surface of a roller made of an extremely hard metal material in accordance with minute protrusions, the roller being a machining tool to be pressed upon a member made of a metal material, thereby forming the protrusions on the surface of the member.

Also, according to the present invention, when the surface of the roller being rotated is irradiated at the same spots with a laser beam per rotation of the roller, the irradiation being performed a plurality of times, thereby forming the recesses of a desired shape, it is possible to finely adjust pitches at which to form the recesses.

### BRIEF DESCRIPTION OF THE DRAWINGS

FIG. 1 is a perspective view illustrating a schematic configuration of a roller machining apparatus according to Embodiment 1 of the present invention.

FIG. 2 is a perspective view illustrating a mask portion, a collecting lens, and a roller in conjunction with the function of the mask portion in the apparatus.

FIG. 3 is a top view of a recess formed in the surface of the roller.

FIG. 4 is a graph illustrating exemplary adjustments in diameter of a laser beam.

FIG. 5 is a perspective view illustrating a schematic configuration of a roller machining apparatus according to Embodiment 2 of the present invention.

FIG. 6 is a perspective view illustrating an encoder and a pulse converter of the apparatus of FIG. 5.

FIG. 7 is a graph illustrating output signals of the encoder.

FIG. 8 is a perspective view illustrating a general incremental rotary encoder connected to the roller.

FIG. 9A is a graph illustrating an A transmission signal in an output signal from the incremental rotary encoder.

FIG. 9B is a graph illustrating a B transmission signal in the output signal from the incremental rotary encoder.

FIG. 9C is a graph illustrating a signal obtained by quadrupling the output signal from the incremental rotary encoder.

FIG. 9D is a graph illustrating a signal that alternately turns ON and OFF every 60 counts of the quadrupled signal.

FIG. 10A is a top view showing recesses formed by a conventional roller machining method.

FIG. 10B is a perspective view showing the recesses.

FIG. 11 is a perspective view showing recesses formed by another conventional roller machining method.

FIG. 12 is a perspective view of a roller to be referenced for explaining problems in forming recesses by conventional roller machining methods.

### BEST MODE FOR CARRYING OUT THE INVENTION

The present invention is directed to a roller machining method for forming a plurality of recesses in a surface of a roller made of a metal material. The present method includes the steps of: (a) rotating the roller in its circumferential direction; (b) detecting a rotational position of the roller; and (c) irradiating the roller at the same spots on the surface with a laser beam per rotation of the roller, the irradiation being repeated a plurality of times, thereby forming the recesses in the surface of the roller.

Also, the present invention is directed to a roller machining apparatus for forming a plurality of recesses in a surface of a roller made of a metal material. The present apparatus includes: a laser oscillator for outputting a laser beam; a machining head having a function of collecting the laser beam outputted by the laser oscillator, such that the surface of the roller is irradiated at a predetermined position with the laser beam; roller rotation means for rotating the roller; rotational position detection means for outputting a signal in accordance with a position of the roller being rotated; and control means for controlling the laser oscillator based on the signal outputted by the rotational position detection means, such that the surface of the roller is irradiated at the same spots with the laser beam per rotation of the roller, the irradiation being performed a plurality of times, thereby forming the recesses in the surface of the roller.

In the present invention thus configured, a recess is formed by irradiating the same spot with a laser beam per rotation of the roller, the irradiation being performed a plurality of times, rather than continuous single irradiation with the laser beam. Therefore, the energy for single laser beam irradiation is small, and spots on the roller surface irradiated with the laser beam are cooled before the next laser beam irradiation. Thus, it is possible to alleviate any adverse thermal effect of the laser beam, and form minute recesses of a desired shape in the roller surface.

As a result, even when the roller is intended to press the surface of a member made of a metal material, such as a current collector, thereby forming a number of protrusions on the surface of the member, and the material of the roller is extremely hard metal, such as cemented carbide, powder metallurgy high-speed steel, or tempered steel, recesses of a desired shape that match the protrusions can be formed in the surface of the roller. For example, it is possible to form minute recesses each being 5 to 50 μm in depth and having an opening and a bottom surface that are generally rhombic.

Also, when the surface of the roller made of such a material is subjected to DLC coating (DLC: Diamond Like Carbon), or PVD coating (PVD: Physical Vapor Deposition) including titanium coating with TiN, TiCN, or the like, it is also possible to form recesses of a desired shape.

To describe it in detail, extremely hard metal, including cemented carbide, powder metallurgy high-speed steel, and tempered steel, has a significant temperature difference between its melting point and boiling point, and is not sublimated even when irradiated with a laser beam, mostly remaining in the recess while maintaining its melted state. If thermal expansion adds any adverse effect, the recess to be formed differs in shape from the outline of the laser beam, and cannot be formed in a desired shape.

Also, the method of the present invention further includes the steps of: (d) generating a pulse signal per rotation of the roller by a predetermined angle based on the detected position of the roller; and (e) setting the number of pulse signals to be generated per rotation of the roller based on pitches at which to form the recesses in the surface of the roller. In the present invention as described, step (c) counts the number of generated pulse signals, and irradiates the roller surface with the laser beam each time the number reaches a number corresponding to the pitch.

Also, the apparatus of the present invention further includes pulse signal generation means for generating a pulse signal per rotation of the roller by a predetermined angle based on the detected position of the roller, and pulse number setting means for setting the number of pulse signals to be generated per rotation of the roller based on pitches at which to form the recesses in the surface of the roller. Here, the control means controls the laser oscillator to count the number of pulses, and irradiate the surface of the roller with the laser beam each time the number reaches a number corresponding to the pitch.

At this time, the number of pulse signals set in step (e) may be either divisible by the number of pulse signals corresponding to the pitch or indivisible by the number, leaving a remainder equal to or less than a predetermined value.

With the above configuration, the surface of the roller being rotated is irradiated at the same spots with a laser beam per rotation of the roller, the irradiation being performed a plurality of times, thereby forming recesses at predetermined pitches. In this case, the position of the roller being rotated is detected, and a pulse signal is generated per rotation of the roller by a predetermined angle, based on the detected position of the roller.

In addition, the number of pulse signals to be generated per rotation of the roller is set in accordance with the pitches at which to form the recesses in the surface of the roller, and the roller surface is irradiated with the laser beam each time the number of generated pulse signals reaches the number corresponding to the pitch. Thus, the roller surface is irradiated with a laser beam each time the roller is rotated by an angle corresponding to the pitch, such that the same spots are irradiated with a laser beam per rotation of the roller, the irradiation being performed a plurality of times, making it possible to form recesses at predetermined pitches.

Here, the number of pulse signals to be generated per rotation of the roller is set based on pitches at which to form recesses in the roller surface, and therefore minute recesses can be formed in the roller surface at various pitches.

More concretely, the number of pulse signals per rotation of the roller is set to either a number divisible by the number of pulse signals that matches the pitch or a number leaving a remainder equal to or less than a predetermined value such that a deviation of an irradiation point per rotation does not exceed a tolerable range. As a result, when the roller makes a rotation after the roller is irradiated at a predetermined spot on the surface with a laser beam, and the same spot is irradiated again with the laser beam, the irradiation point can be prevented from deviating beyond the tolerable range. Thus, the surface of the roller being rotated can be accurately irradiated at the same spots with a laser beam per rotation of the roller.

Also, the method of the present invention may include the step of: (f) preselecting and storing a candidate for the number of pulse signals to be set in step (e) in accordance with a diameter of the roller.

This allows formation of recesses at various pitches in surfaces of rollers in the same diameter by calling up and setting a stored pulse number.

Also, in a preferred embodiment of the present invention, step (c) includes the steps of: (g) shaping the outline of the laser beam to be similar in shape to the recesses; and (h) condensing the laser beam having the shaped outline, thereby forming an image on the surface of the roller.

As a result, the roller surface is irradiated with a laser beam having its outline similar in shape to the recesses and being condensed for imaging, so that minute recesses having a more desirable shape can be formed. Specifically, with the above configuration, the outline of the laser beam is shaped while keeping the outline relatively large, and therefore diffusion of the laser beam due to, for example, diffraction can be suppressed.

The laser beam having its outline thus shaped can be collected with high accuracy while minimizing aberration, so that an image of a desired shape is formed on the roller surface. Thus, it becomes possible to render the recesses in a desired shape with higher accuracy.

As a result, it is possible to form circular recesses in the roller surface, and even recesses of a desired shape (e.g., rhombus) having an opening with a long axis diameter of 6 to 40 μm, a short axis diameter of 3 to 20 μm, and a depth of 5 to 50 μm.

### Embodiment 1

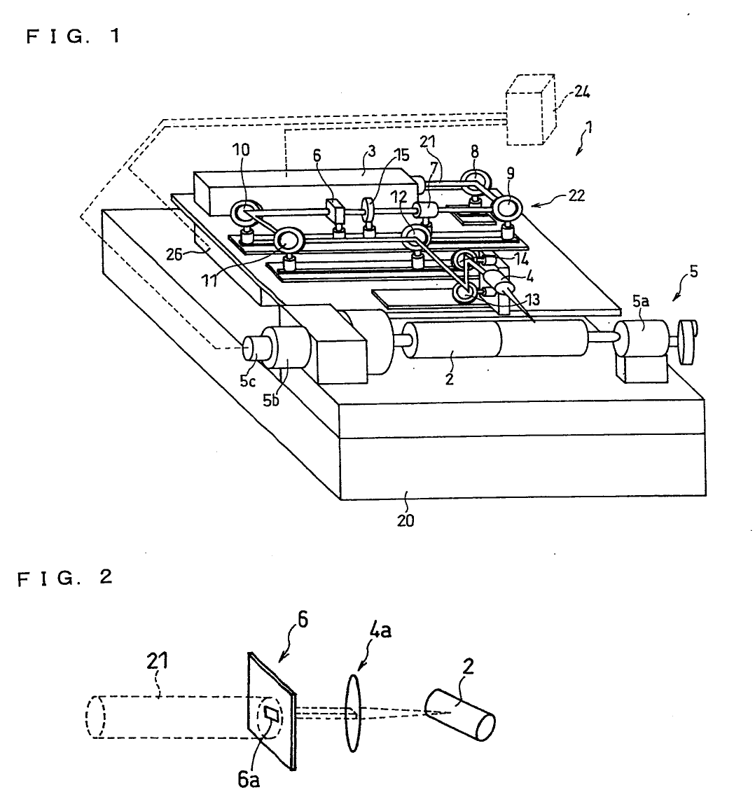

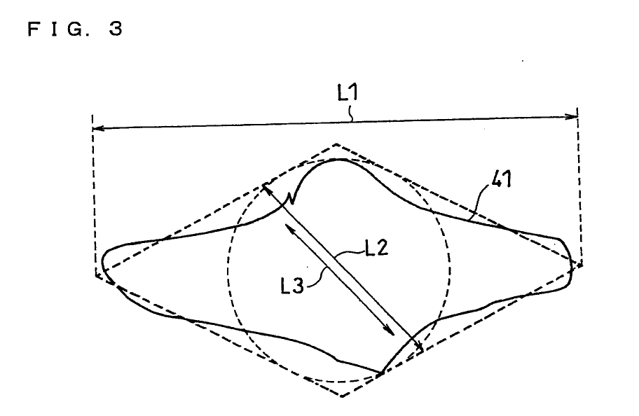

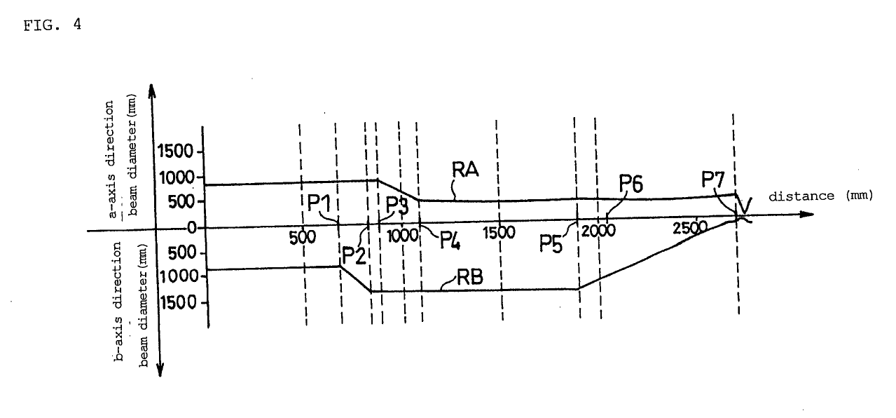

Hereinafter, an embodiment of the present invention will be described with reference to FIGS. 1 to 4. FIG. 1 is a perspective view illustrating a schematic configuration of a roller machining apparatus according to Embodiment 1 of the present invention. FIG. 2 is a perspective view illustrating a mask portion, a collecting lens, and a roller in conjunction with the function of the mask portion in the apparatus. FIG. 3 is a top view of a recess formed in the surface of the roller. FIG. 4 is a graph illustrating exemplary adjustments in diameter of a laser beam in a light path.

The roller machining apparatus 1 of FIG. 1 is an apparatus for forming recesses 41 (see FIG. 3) in the surface of a roller 2 for use in pressing an unillustrated battery current collector made of a metal material, thereby forming a number of minute protrusions having a predetermined shape on the surface of the collector, in which the recesses are shaped to accord with the protrusions.

More concretely, the roller machining apparatus 1 includes a laser oscillator 3 for outputting a laser beam 21, and a machining head 4 for collecting the laser beam 21 and irradiating the surface of the roller 2 with the collected beam. The roller machining apparatus 1 also includes a roller rotating device 5 for rotatably supporting the roller 2 and rotationally driving the roller 2 in its circumferential direction.

The laser oscillator 3 and the machining head 4 are supported by a two-axis actuator 26 so as to be movable in parallel to a horizontal plane. The two-axis actuator 26 and the roller rotating device 5 are mounted on a stone surface plate 20.

The roller machining apparatus 1 also includes a control portion 24 for controlling, for example, the time at which the laser oscillator 3 performs output (also referred to below as “emission”) of the laser beam 21.

The roller 2 is intended, for example, to be used for forming protrusions on the surface of a battery current collector made of a metal material, and is produced from an extremely hard material, such as cemented carbide, powder metallurgy high-speed steel, or tempered steel, (see Examples below). The laser oscillator 3 is configured by, for example, a solid-state laser oscillator (Nd:YAG laser or Nd:YVO₄ laser) using a laser medium obtained by doping a YAG (yttrium aluminum garnet) or YVO₄ (yttrium vanadate) crystal with neodymium ions.

The roller rotating device 5 includes a tailstock 5a for supporting the roller 2 so as to be rotatable in its circumferential direction, a motor 5b for rotationally driving the roller 2, and an encoder 5c for outputting a signal in accordance with a rotational position of the roller 2. The signal outputted by the encoder 5c is inputted to the control portion 24.

Also, a plurality of reflection mirrors 8 to 14 for guiding the laser beam 21 to the machining head 4, an attenuator 7, beam diameter adjusters 15 for adjusting the diameter of the laser beam 21, and the mask portion 6 for shaping the outline of the laser beam into a desired shape are arranged in a light path 22 of the laser beam 21 from the laser oscillator 3 to the machining head 4. These members arranged in the light path 22, along with the laser oscillator 3 and the machining head 4, are freely moved by the two-axis actuator 26 in parallel to a horizontal plane.

The attenuator 7 adjusts polarizing directions of the laser beam 21 so as to transmit or reflect components only in a specific polarizing direction, thereby controlling or regulating an output (energy) of the laser beam 21.

Next, the mask portion 6 will be described with reference to FIG. 2. The mask portion 6 includes a laser beam passage hole 6a having a shape (e.g., rhombus) similar to the shape of a recess to be formed in the surface of the roller 2. The laser beam 21 has its outline shaped into the aforementioned shape by passing through the laser beam passage hole 6a, and is condensed for imaging onto the surface of the roller 2 by the collecting lens 4a of the machining head 4.

As a result, a recess 41 of a desired shape can be formed in the surface of the roller 2 such that its planar shape is noncircular and the ratio of short axis diameter L2 to long axis diameter L1 is, for example, 0.8 or less, as shown in FIG. 3. Here, the long axis length L1 is, for example, 6 to 40 μm, and the short axis length L2 is, for example, 3 to 20 μm.

In this case, the machining head 4 preferably irradiates the surface of the roller 2 with the laser beam 21 such that 90% or more of the laser beam energy is applied within an area with the diameter L3 less than the short axis length L2. As a result, any effect of thermal expansion can be alleviated, making it possible to form the recess 41 in a more desirable shape.

Next, the beam diameter adjuster 15 will be described. The beam diameter adjuster 15 regulates energy distribution and a broadening angle of the laser beam 21 such that energy is high in an area corresponding to the laser hole passage hole 6a of the mask portion 6, and includes at least one lens. Thus, it is possible to achieve enhancement of energy efficiency, protection of the mask portion 6, and reduction of aberration caused in the machining head 4. Note that in FIG. 1, only one beam diameter adjuster 15 is shown for legibility. However, in practice, the beam diameter adjuster 15 may be disposed at plural portions in the light path 22.

Hereinafter, an example of adjusting the diameter of the laser beam 21 using the beam diameter adjuster 15 and so on will be described with reference to FIG. 4. In the example shown, the laser beam 21 has its diameter expanded in a b-axis direction (vertical direction) by an unillustrated beam diameter adjuster 15 configured by a cylindrical lens disposed at point P1 distanced about 700 mm from the laser oscillator 3 in the light path 22. Then, the diametric expansion of the beam in the b-axis direction is stopped by an unillustrated beam diameter adjuster 15 configured by a cylindrical lens disposed at point P2 lying at approximately a 900 mm distance.

Next, the beam has its diameter contracted in an a-axis direction (horizontal direction) by an unillustrated beam diameter adjuster 15 configured by a cylindrical lens disposed at point P3 lying at approximately a 1000 mm distance, and the diametric contraction of the beam in the a-axis direction is stopped by an unillustrated beam diameter adjuster 15 configured by a cylindrical lens disposed at point P4 lying at approximately a 1200 mm distance.

Furthermore, the beam has its diameter contracted in the b-axis direction by an unillustrated beam diameter adjuster 15 configured by a circular lens disposed at point P5 lying at approximately a 2000 mm distance. Thus, the laser beam 21 can be collected toward the laser beam passage hole 6a of the mask portion 6 disposed at point P6 lying at approximately a 2100 mm distance. By passing through the laser beam passage hole 6a of the mask portion 6, the laser beam 21 has its outline shaped like, for example, a rhombus. Thereafter, the laser beam 21 is collected by the collecting lens 4a of the machining head 4 disposed at point P7. Thus, the surface of the roller 2 is irradiated with the laser beam 21 having its outline shaped like, for example, a rhombus by the mask portion 6 and being condensed for imaging.

Note that the beam diameter adjusters 15 can also be configured using DOEs (Diffractive Optical Elements), slits, or filters, rather than using lenses.

Next, an operation of the roller machining apparatus 1 will be described where recesses 41 are formed in the surface of the roller 2 under control of the control portion 24.

The recesses 41 are formed row by row from one end (e.g., the tailstock 5a side end) of the surface of the roller 2, which is being rotationally driven by the roller rotating device 5, so as to be arranged at predetermined pitches in the circumferential direction. In this case, the control portion 24 controls the two-axis actuator 26 to move the machining head 4 to a position corresponding to a row in which to form the recesses 41. Then, based on an output signal from the rotary encoder 5c, the laser oscillator 3 is controlled to irradiate the surface of the roller 2 with a laser beam 21 upon each rotation of the roller 2 by an angle corresponding to the pitch. At this time, the energy of the laser beam 21 applied to the surface of the roller 2 is a fraction of the energy required for forming a desired recess 41.

When the roller 2 is so rotated, the control portion 24 performs such control as to apply the laser beam 21 to the same spot as that irradiated with the laser beam 21 in the previous round. This is repeated a predetermined number of times (e.g., 5 to 8 times), thereby forming a row of recesses 41. When a row of recesses 41 are formed, the control portion 24 controls the two-axis actuator 26 to move the machining head 4 by a predetermined distance in the axial direction of the roller 2 in order to form the next row of recesses 41.

Here, the surface of the roller 2 is irradiated with the laser beam 21 for 10 ps to 200 ns per irradiation. This is because when the irradiation time is 10 ps or less, almost no thermal conduction occurs so that only a thickness of one atomic layer to 0.1 μm is removed per irradiation. On the other hand, if it is more than 200 ns, rotation of the roller 2 causes the laser beam to sweep the roller surface, so that it is not possible to achieve sufficient positional precision required for recess machining on the order of micron scale. For example, when the roller 2 has a diameter of 130 mm and a rotational speed of 60 rpm, if the irradiation time is 200 ns or less, it is possible to maintain the amount of sweep in the surface of the roller 2 at 0.08 μm or less.

Also, the wavelength of the laser beam 21 emitted from the laser oscillator 3 is preferably 100 to 600 nm, the focal length of the machining head 4 is preferably 20 to 200 mm, and the imaging magnification ratio is preferably 5 to 40 times. More preferably, the focal length is about 40 mm. This is because when the focal length is too short, machining dust generated from the roller 2 adheres to the collecting lens 4a of the machining head 4. Also, when the focal length is too long, the collecting lens 4a is reduced in NA (numerical aperture), failing to form an image. Also, the imaging magnification ratio is more preferably about 16 times.

Also, more preferably, the laser beam 21 has a wavelength of 266 to 600 nm. The reason for this is that when the wavelength of the laser beam 21 exceeds 600 nm, diffraction increases, leading to accuracy deterioration. Also, when the laser beam 21 has a wavelength of less than 266 nm, sufficient power is not provided. In such a case, an Nd:YAG laser of such a type as to generate harmonics using a nonlinear optical crystal may be applied as the laser oscillator 3, thereby outputting green light having a wavelength of 532 nm or ultraviolet light having a wavelength of 355 nm.

Also, depending on the NA of the collecting lens 4a of the machining head 4 and the wavelength of the laser beam 21, the laser passage hole 6a of the mask portion 6 may be shaped not to have any corner with a curvature radius of less than 10 μm, in order to prevent the laser beam 21 from diffusing due to diffraction. This applies to the case where the laser beam 21 has a wavelength of approximately 200 nm. However, for example, when the collecting lens of the machining head 4 has an NA of 0.3, and the laser beam 21 has a wavelength of 500 nm, the diffraction limit is 2.0 μm. Here, if diffraction light is used to the first order, the minimum beam diameter is about 3 μm, and therefore the curvature radius needs to be 24 μm or more for the magnification ratio of 16 times.

Hereinafter, examples of the invention, along with comparative examples, will be described in conjunction with Embodiment 1. Note that the present invention is not limited to these examples.

### Example 1

A W—Co cemented carbide roller manufactured by Fuji Die Co., Ltd. was used as a roller 2 in which recesses 41 are formed. The roller 2 was 100 mm in width and 50 mm in diameter. The roller 2 was set to the roller rotating device 5 of the roller machining apparatus 1, and rotated at a rotational speed of 11 rpm.

A target shape of the recess was a rhombus with a short axis diameter of 11 μm and a long axis diameter of 22 μm. The mask portion 6 was a gold-plated stainless steel plate having a rhombic opening with a short axis diameter of 150 μm and a long axis diameter of 300 μm formed by discharge machining as a laser beam passage hole 6a, and was disposed at a position on a light path with an imaging ratio of 16:1.

An Nd:YAG second harmonic laser (wavelength: 532 nm, pulse width: about 50 ns) manufactured by Spectra-Physics K.K. was used as a laser oscillator 3, which was controlled to emit a laser beam at times corresponding to 29.1 μm pitches on the roller surface.

The beam diameter adjuster 15 shaped the laser beam 21 so as to have a diameter of 1.0 mm, thereby allowing the beam to pass through the laser beam passage hole 6a of the mask portion 6, so that the machining head 4 irradiated the surface of the roller 2 with the beam. A machining point laser output was set at 25 μJ, and recesses 41 were formed by repeating irradiation to the same spots eight times. Also, when a row of recesses 41 were formed, the machining head 4 was moved by 22 μm in the axial direction of the roller 2 to form recesses 41 in the surface of the roller 2 in the same manner as that for the previous row. In this manner, the recesses 41 were formed within a 90-mm width in the surface of the roller 2. At this time, the timing of emitting the laser beam 21 was regulated such that positions of the recesses 41 to be formed in the circumferential direction of the roller 2 were out of alignment between adjacent rows in the circumferential direction. As a result, the recesses 41 were formed in the surface of the roller 2 in an oblique lattice or zigzag arrangement.

A microscopic observation of the surface of the roller 2 machined under the above conditions showed the openings to be in the shape of a rhombus with a short axis diameter of 11 μm, a long axis diameter of 22 μm, and a depth of 10 μm. In this manner, it was observed that, according to the present invention, recesses can be formed in a more desirable shape compared to comparative examples to be described later in relation to conventional art.

### Example 2

A powder metallurgy high-speed roller manufactured by Hitachi Metals, Ltd. was used as a roller 2 in which recesses 41 are formed. This roller 2 was set to the roller rotating device 5 of the roller machining apparatus 1, and rotated at a rotational speed of 22 rpm. A target shape of the recess 41 was a rhombus with a short axis diameter of 7 μm and a long axis diameter of 24 μm. The mask portion 6 had a laser beam passage hole 6a in the shape of a rhombus with a short axis diameter of 150 μm and a long axis diameter of 400 μm.

A machining point laser output was set at 18 μJ, and recesses 41 were formed by repeating irradiation to the same spots five times. When a row of recesses 41 were formed, the machining head 4 was moved by 25 μm in the axial direction of the roller 2. The recesses 41 were formed in the surface of the roller 2 in the same manner as in Example 1 under the same conditions except for those as described above.

A microscopic observation of the surface of the roller 2 machined under the above conditions showed the openings to be in the shape of a rhombus with a short axis diameter of 7 μm, a long axis diameter of 24 μm, and a depth of 12 μm. In this manner, it was observed that, according to the present invention, recesses can be formed in a more desirable shape compared to comparative examples to be described later in relation to conventional art.

### Example 3

A tempered steel roller manufactured by Daido Machinery, Ltd. was used as a roller 2 in which recesses 41 are formed. This roller 2 was set to the roller rotating device 5 of the roller machining apparatus 1, and rotated at a rotational speed of 22 rpm. A target shape of the recess 41 was a rhombus with a short axis diameter of 7 μm and a long axis diameter of 25 μm. The mask portion 6 had a laser beam passage hole 6a in the shape of a rhombus with a short axis diameter of 100 μm and a long axis diameter of 400 μm.

A machining point laser output was set at 18 μJ, and recesses 41 were formed by repeating irradiation to the same spots five times. When a row of recesses 41 were formed, the machining head 4 was moved by 25 μm in the axial direction of the roller 2. The recesses 41 were formed in the surface of the roller 2 in the same manner as in Example 1 under the same conditions except for those as described above.

A microscopic observation of the surface of the roller 2 machined under the above conditions showed the openings to be in the shape of a rhombus with a short axis diameter of 10 μm, a long axis diameter of 25 μm, and a depth of 12 μm. In this manner, it was observed that, according to the present invention, recesses can be formed in a more desirable shape compared to comparative examples to be described later in relation to conventional art.

### Comparative Example 1

A tempered steel roller manufactured by Daido Machinery, Ltd. was used as a roller 2 in which recesses 41 are formed. This roller 2 was set to the roller rotating device 5 of the roller machining apparatus 1. A target shape of the recess was a rhombus with a short axis diameter of 7 μm and a long axis diameter of 25 μm. The mask portion 6 had a laser beam passage hole 6a in the shape of a rhombus with a short axis diameter of 100 μm and a long axis diameter of 400 μm.

An Nd:YAG second harmonic laser (wavelength: 532 nm, pulse width: about 50 ns) manufactured by Spectra-Physics K.K. was used as a laser oscillator 3. After repeatedly shooting a laser beam 21 to the same spot five times at 2 kHz with the roller 2 being static, the roller 2 was then rotated and stopped again when the laser beam irradiation point moved 29 μm, and a laser beam was repeatedly shot to the same spot five times at 2 kHz, and this procedure was repeated to form recesses at 29 μm pitches. A machining point laser output was set at 18 μJ. When a row of recesses 41 were formed, the machining head 4 was moved by 25 μm in the axial direction of the roller 2 to form recesses 41 in the surface of the roller 2 in the same manner as that for the previous row. The recesses 41 were formed in the surface of the roller 2 in the same manner as in Example 1 under the same conditions except for those as described above.

A microscopic observation of the surface of the roller 2 machined under the above conditions showed the openings to be in the shape of a rhombus with a short axis diameter of 14 μm, a long axis diameter of 22 μm, and a depth of 11 μm. This result significantly deviated from the above target shape in that the short axis diameter was about 7 μm larger than the target shape of the 7×25 μm rhombus.

### Embodiment 2

Next, Embodiment 2 of the present invention will be described. Embodiment 2 is a modification to Embodiment 1, and differences therebetween will be mainly described below.

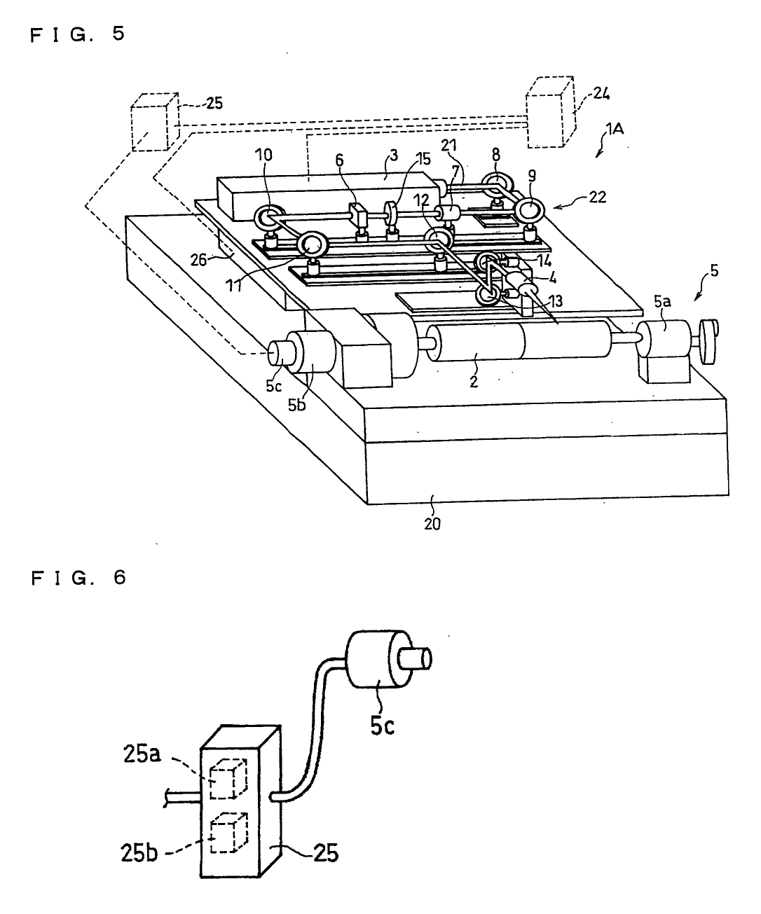

FIG. 5 illustrates a schematic configuration of a roller machining apparatus according to Embodiment 2.

The roller machining apparatus 1A is realized by adding a pulse converter 25 to the roller machining apparatus 1 in Embodiment 1. Also, an encoder 5c is configured using an absolute rotary encoder for outputting a signal corresponding to an absolute position of the roller 2. The output signal from the encoder 5c is inputted to the control portion 24 via the pulse converter 25.

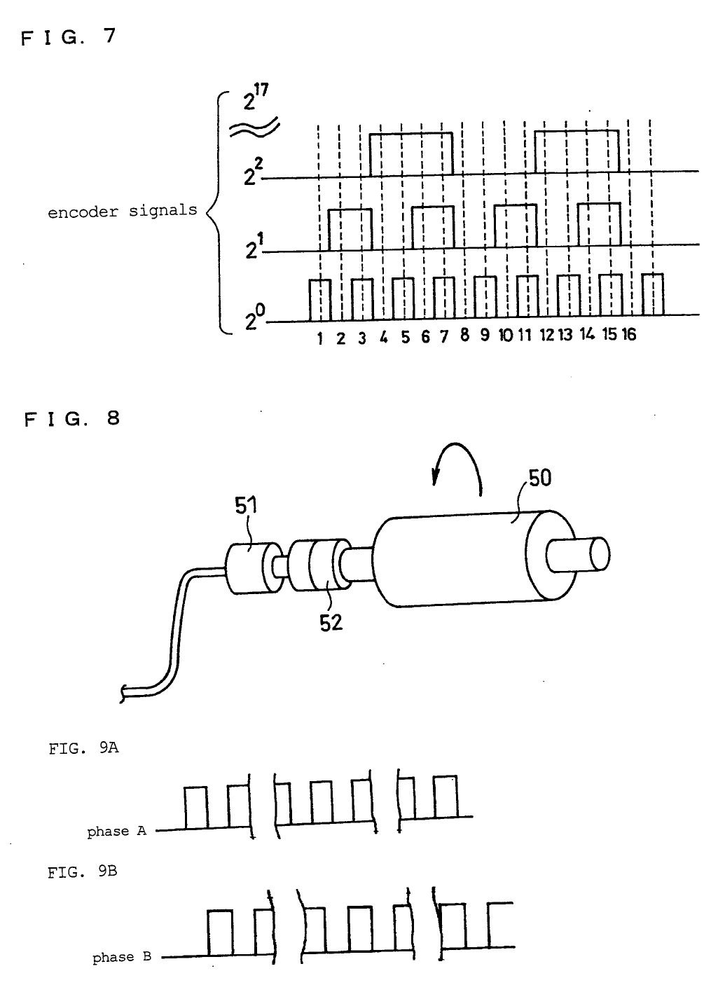

Next, the encoder 5c and the pulse converter 25 will be described in detail with reference to FIGS. 6 and 7. The encoder 5c acting as an absolute rotary encoder outputs a signal (e.g., gray code) of a predetermined number of bits (in the example shown, 17 bits) corresponding to the absolute rotational position of the roller 2. This allows the absolute rotational position of the roller 2 to be detected without counting the number of signals from a reference position.

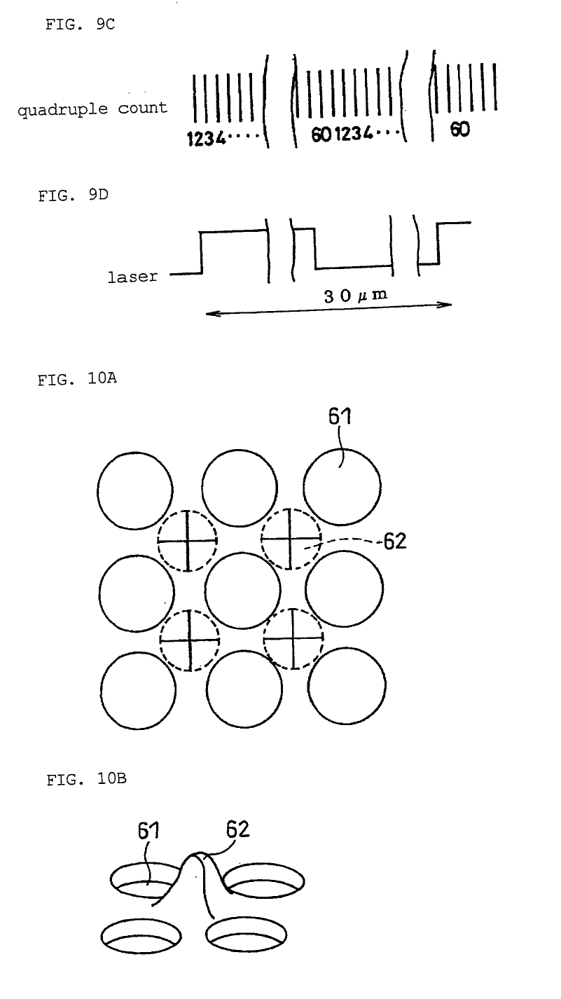

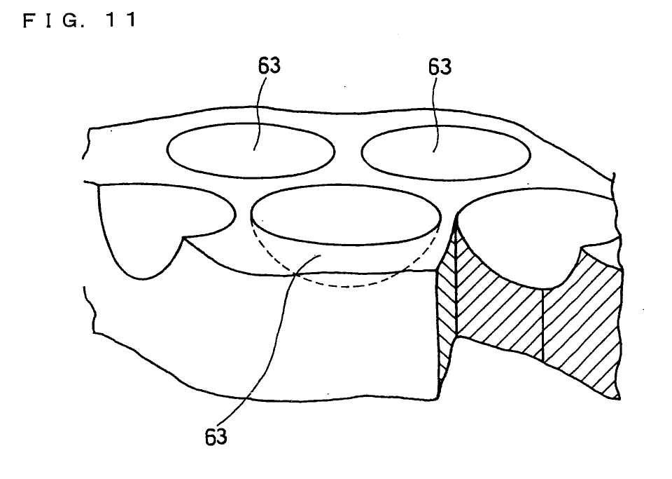

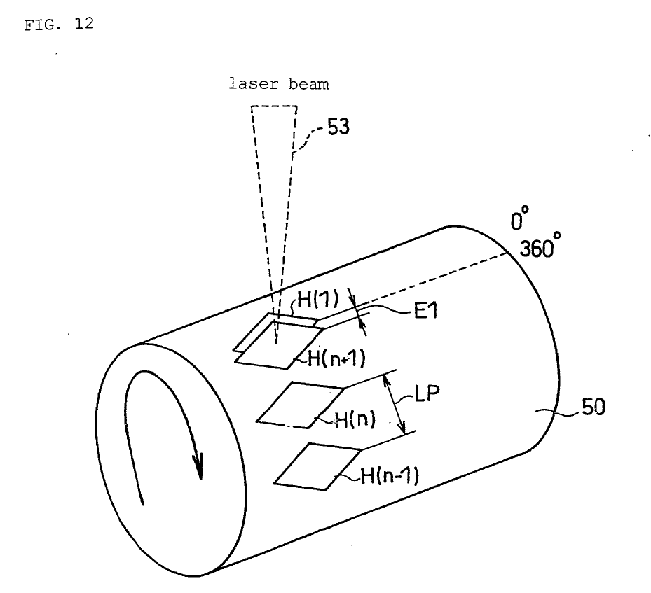

The pulse converter 25 includes a pulse signal generation portion 25a and a pulse number setting portion 25b. The pulse signal generation portion 25a generates two pulse signals (phase-A and phase-B signals; see FIGS. 9A and 9B) based on the output signal from the encoder 5c, the pulse signals being equal in cycle and pulse width but different in phase. The pulse number setting portion 25b sets the number for each of the two pulse signals per rotation of the roller 2, in accordance with pitches at which to form recesses in the surface of the roller 2. Note that in FIG. 6, although the pulse signal generation portion 25a and the pulse number setting portion 25b are disposed separately, the pulse signal generation portion 25a and the pulse number setting portion 25b may be configured by providing chips on a single substrate, which function as the pulse signal generation portion 25a and the pulse number setting portion 25b, respectively.

Hereinafter, the control procedure according to Embodiment 2 will be described taking concrete numeral examples for easy understanding of the present invention. Here, it is assumed that recesses 41 are formed in the surface of the roller 2 having a diameter of 125 mm. Note that the numerical values are merely illustrative for convenience of the description.

(1) The number of pulses per rotation of the roller 2 is preset by the pulse converter 25 for phase-A and phase-B signals to be generated based on the output signal from the encoder 5c. For example, when the output signal from the encoder 5c is of 17 bits, the number of pulses is 131072 per rotation of the roller 2. Considering the diameter (125 mm) of the roller 2, the operator presets the pulse converter 25 such that the phase-A and phase-B signals can be generated from the signal of 131072 pulses in 16 patterns of pulse number per rotation of the roller 2, the number incrementing by 100 in the order, for example: 2400, 2500, . . . , 3900. The pulse converter 25 generates and outputs phase-A and phase-B signals further selected by the operator from among the signals of the 16 preset pulse numbers.

(2) The number of pulses to be obtained by quadrupling the preset pulse number is calculated for each of the phase-A and phase-B signals. As a result, 16 quadrupled pulse numbers are derived, the numbers incrementing by 400 in the order: 9600 (=2400×4), 10000 (=2500×4), . . . , 15600 (=3900×4).

(3) The number of holes to be provided per rotation of the roller 2 for forming recesses 41 at desired pitches is calculated. For example, when forming the recesses 41 in the surface of the roller 2 having a diameter of 125 mm at various pitches: 28 μm, 29 μm, 30 μm, and 31 μm, the respective numbers of holes per rotation are 14025 (≈125×π÷0.028), 13541 (≈125×π÷0.029), 13090 (≈125×π÷0.030), 12668 (≈125×π÷0.031).

(4) The pulse number closest to the calculation result in procedure 3 above is selected from the pulse numbers quadrupled in procedure 2 above. For example, the pulse number 14000 (=3500×4) is selected for 28 μm pitches, the pulse number 13600 (=3400×4) is selected for 29 μm pitches, the pulse number 13200 (=3300×4) is selected for 30 μm pitches, and the pulse number 12800 (=3200×4) is selected for 31 μm pitches.

(5) The pulse number corresponding to the quadrupled pulse number selected in procedure 4 above for each of the phase-A and phase-B signals is selected from among the pulse numbers set in procedure 1 above. For example, the pulse number 3500 (=14000÷4) is selected for 28 μm pitches, the pulse number 3400 (=13600÷4) is selected for 29 μm pitches, the pulse number 3300 (=13200÷4) is selected for 30 μm pitches, and the pulse number 3200 (=12800÷4) is selected for 31 μm pitches. At this time, if the roller 2 is 125 mm in diameter, actual pitches are 28.05 (≈125×π÷14000) μm (error: 0.05 μm), 28.87 (≈125×π÷13600) μm (error: 0.13 μm), 29.75 (≈125×π÷13200) μm (error: 0.25 μm), and 30.70 (≈125×π÷12800) μm (error: 0.30 μm).

As described above, by causing the pulse converter 25a to set 16 patterns of pulse number for a signal to be generated per rotation of the roller 2 having a diameter of 125 mm based on the output signal from the encoder 5c in such a manner that the pulse number increments by 100 from 2400 to 3900, it becomes possible to form the recesses 41 in the surface of the roller 2 at 16 pitches varying by 1 μm increments from 24 to 39 μm pitches with only a slight error. In the above example, even if the diameter of the roller 2 is changed, it is possible to address such a change by adjusting the set increment (in the above example, 100) between the set pulse numbers. Also, when it is necessary to form recesses at pitches (e.g., 20 μm or 42 μm pitches) outside the above range, the range of set pulse numbers (in the above example, 2400 to 3900) may be changed.

Hereinafter, a case where recesses 41 are formed at predetermined pitches in the surface of the roller 2 in conventional art will be described for reference. An encoder (here, incremental rotary encoder) 51 shown in FIG. 8 is connected to a roller 50 via a coupling 52.

The encoder 51 outputs phase-A and phase-B signals, which are pulse signals as shown in FIGS. 9A and 9B, via rotation of the roller 50. Here, assuming that the number of pulses per rotation of the roller 50 is 81000 for each of the phase-A and phase-B signals, when the phase-A signal and the phase-B signal are each quadrupled, the number of signals is 324000, as shown in FIG. 9C.

Assuming a case of generating a signal that alternately turns ON and OFF every 60 counts of the quadrupled signal, and applying a laser beam 21 each time the signal turns ON/OFF, as shown in FIG. 9D, if the roller 50 is 50 mm in diameter, 5400 (=324000÷60) recesses 41 are formed in the surface of the roller 50 at about 29.1 (≈50000 (50 mm)×π÷5400) μm pitches.

When this method is used to form recesses at, for example, 28 μm pitches, a signal that alternately turns ON and OFF every 58 counts of the quadrupled signal may be generated, and the laser beam 21 may be applied each time the signal turns ON/OFF. However, division of 324000, which is the number of signals per rotation of the roller 50, by 58 results in about 5586.2 (the remainder of the division being 12). As such, the remainder “12” occurs due to indivisibility, and therefore in this example, a significant deviation of about 6 μm occurs, which is equivalent to 12 counts per rotation of the roller 50. Accordingly, it is not possible to irradiate the surface of the roller 2 at the same spots with a laser beam per rotation of the roller 2.

Therefore, the recesses can be formed only at pitches corresponding to counts that can divide the number of signals (324000) per rotation of the roller 50 or that cannot divide the number but leave only a small remainder. In this example, the recesses 41 can be formed only at pitches of 26 μm, 29 μm, and 32 μm incrementing by 3 μm. Accordingly, to form recesses at 27 or 28 μm pitches, it is necessary to use another rotary encoder that outputs a different number of signals per rotation.

In this regard, according to the present invention, it is possible to four recesses in the surface of the roller 2 using one rotary encoder while freely selecting pitches.

Hereinafter, examples of the present invention will be described in conjunction with Embodiment 2. Note that the present invention is not limited to these examples.

### Example 4

A W—Co cemented carbide roller manufactured by Fuji Die Co., Ltd. was used as a roller 2 for forming recesses 41. The roller 2 was 100 mm in width and 50 mm in diameter. The roller 2 was set to the roller rotating device 5 of the roller machining apparatus 1A, and rotated at a rotational speed of 11 rpm.

An optical absolute rotary encoder was used as an encoder 5c. This encoder 5c outputs a 17-bit signal (e.g., gray code) corresponding to the absolute rotational position, and its maximum rotational speed is 2000 rotations/min. Also, a differential line driver is used for data transmission.

The pulse converter 25 used receives the 17-bit signal outputted by the encoder 5c at the differential line receiver, and outputs two pulse signals (phase-A and phase-B signals) different in phase and a pulse signal (origin signal) indicating a specific angular position. This pulse converter receives a pulse number selection signal in binary form, and thereby outputs phase-A and phase-B signals of a preset pulse number. Here, the pulse converter 25 was preset with 16 pulse counts incrementing by 100 from 2400 to 3900 as pulse numbers per rotation of the roller.

A target shape of the recess 41 was a rhombus with a short axis diameter of 11 μm and a long axis diameter of 22 μm. The mask portion 6 was a gold-plated stainless steel plate having a rhombic opening with a short axis diameter of 150 μm and a long axis diameter 300 μm formed by discharge machining as a laser beam passage hole 6a, and was disposed at a position on a light path with an imaging ratio of 16:1.

An Nd:YAG second harmonic laser (wavelength: 532 nm, pulse width: about 50 ns) manufactured by Spectra-Physics K.K. was used as a laser oscillator 3, which was controlled to emit a laser beam at times corresponding to 29 μm pitches on the roller surface.

The beam diameter adjuster 15 shaped the laser beam 21 so as to have a diameter of 1.0 mm, thereby allowing the beam to pass through the laser beam passage hole 6a of the mask portion 6, so that the machining head 4 irradiated the surface of the roller 2 with the beam. A machining point laser output was set at 25 μJ, and recesses 41 were formed by repeating irradiation to the same spots eight times. Also, when a row of recesses 41 were formed, the machining head 4 was moved by 22 μm in the axial direction of the roller 2 to form recesses 41 in the surface of the roller 2 in the same manner as that for the previous row. In this manner, the recesses 41 were formed within a 90-mm width in the surface of the roller 2. At this time, the timing of emitting the laser beam 21 was regulated such that positions of the recesses 41 to be formed in the circumferential direction of the roller 2 were out of alignment between adjacent rows in the circumferential direction. As a result, the recesses 41 were formed in the surface of the roller 2 in an oblique lattice or zigzag arrangement.

A microscopic observation of the surface of the roller 2 machined under the above conditions showed the openings to be in the shape of a rhombus with a short axis diameter of 11 μm, a long axis diameter of 21 μm, and a depth of 10 μm. In this manner, it was observed that, according to the present invention, recesses can be formed in a more desirable shape compared to comparative examples to be described later in relation to conventional art.

### Example 5

A powder metallurgy high-speed roller manufactured by Hitachi Metals, Ltd. was used as a roller 2 in which recesses 41 are formed. This roller 2 was set to the roller rotating device 5 of the roller machining apparatus 1A, and rotated at a rotational speed of 22 rpm. A target shape of the recess 41 was a rhombus with a short axis diameter of 7 μm and a long axis diameter of 24 μm. The mask portion 6 had a laser beam passage hole 6a in the shape of a rhombus with a short axis diameter of 100 μm and a long axis diameter of 400 μm.

A machining point laser output was set at 18 μJ, and recesses 41 were formed by repeating irradiation to the same spots five times. When a row of recesses 41 were formed, the machining head 4 was moved by 25 μm in the axial direction of the roller 2.

A microscopic observation of the surface of the roller 2 machined under the above conditions showed the openings to be in the shape of a rhombus with a short axis diameter of 10 μm, a long axis diameter of 21 μm, and a depth of 12 μm. In this manner, it was observed that, according to the present invention, recesses can be formed in a more desirable shape compared to comparative examples to be described later in relation to conventional art.

### Example 6

A tempered steel roller manufactured by Daido Machinery, Ltd. was used as a roller 2 in which recesses 41 are ft/med. This roller 2 was set to the roller rotating device 5 of the roller machining apparatus 1A, and rotated at a rotational speed of 22 rpm. A target shape of the recess 41 is a rhombus with a short axis diameter of 7 μm and a long axis diameter of 25 μm. The mask portion 6 had a laser beam passage hole 6a in the shape of a rhombus with a short axis diameter of 100 μm and a long axis diameter of 400 μm. A machining point laser output was set at 18 μJ, and irradiation to the same spots was repeated five times. When a row of recesses 41 were formed, the machining head 4 was moved by 25 μm in the axial direction of the roller 2.

A microscopic observation of the surface of the roller 2 machined under the above conditions showed the openings to be in the shape of a rhombus with a short axis diameter of 10 μm, a long axis diameter of 24 μm, and a depth of 11 μm. In this manner, it was observed that, according to the present invention, recesses can be formed in a more desirable shape compared to comparative examples to be described later in relation to conventional art.

While the present invention has been described above with respect to embodiments and examples, the present invention is not limited thereto and various modifications can be made. For example, the number of times to repeat laser beam irradiation is not limited to five to eight times, and may be appropriately increased/decreased within the range where machining speed and machining accuracy are balanced.

Also, a blowing device for blowing gas or liquid onto the surface of the roller 2 may be provided around the roller 2 so that the gas or liquid can be blown onto a spot on the surface of the roller 2 that was irradiated with the laser beam 21 before the next time the same spot is irradiated with the laser beam 21. As a result, dust can be removed from the spot on the surface of the roller 2 that is to be irradiated with the laser beam 21. It is also possible to cool the surface of the roller 2, thereby making it possible to form recesses in a desired shape with higher accuracy.

As for the gas to be blown onto the surface of the roller 2, for example, compressed air might effectively achieve dust removal and cooling, but inert gas, such as nitrogen or argon, may be preferably used to suppress oxidation reaction at the time of machining, thereby reducing unsatisfactory machine shaping due to oxidation heat.

Also, as for the liquid, liquid that instantaneously volatizes at room temperature, such as liquid nitrogen, may be preferably blown around the laser irradiation spot. As a result, it becomes possible to keep the machined surface dry while increasing cooling effect, thereby preventing image formation of the laser beam from being inhibited.

### INDUSTRIAL APPLICABILITY

The roller machining apparatus and the roller machining method according to the present invention allow minute recesses having a desired shape to be formed in the surface of a roller used for pressing a metallic member and forming protrusions on the surface thereof. Thus, the invention is useful for machining rollers for use mainly in producing battery current collectors.

1. A roller machining method for forming a plurality of recesses in a surface of a roller made of a metal material, the method comprising the steps of:
(a) rotating the roller;
(b) detecting a position of the roller being rotated; and
(c) irradiating the roller at the same spots on the surface with a laser beam per rotation of the roller, the irradiation being repeated a plurality of times, thereby forming the recesses in the surface of the roller.

2. The roller machining method according to claim 1, further comprising the steps of:
(d) generating a pulse signal per rotation of the roller by a predetermined angle based on the detected position of the roller; and
(e) setting the number of pulse signals to be generated per rotation of the roller based on pitches at which to form the recesses in the surface of the roller, wherein,
in step (c), the number of generated pulse signals is counted, and the surface of the roller is irradiated with the laser beam each time the number reaches a number corresponding to the pitch.

3. The roller machining method according to claim 2, wherein the number of pulse signals set in step (e) is either divisible by the number of pulse signals corresponding to the pitch or indivisible by the number, leaving a remainder equal to or less than a predetermined value.

4. The roller machining method according to claim 2, comprising the step of: (f) preselecting and storing a candidate for the number of pulse signals to be set in step (e) in accordance with a diameter of the roller.

5. The roller machining method according to claim 1, wherein step (c) includes the steps of:
(g) shaping an outline of the laser beam to be similar in shape to the recesses; and
(h) condensing the laser beam having the shaped outline, thereby forming an image on the surface of the roller.

6. A roller machining apparatus for forming a plurality of recesses in a surface of a roller made of a metal material, the apparatus comprising:
a laser oscillator for outputting a laser beam;
a machining head having a function of collecting the laser beam outputted by the laser oscillator, such that the surface of the roller is irradiated at a predetermined position with the laser beam;
roller rotation means for rotating the roller;
rotational position detection means for outputting a signal in accordance with a position of the roller being rotated; and
control means for controlling the laser oscillator based on the signal outputted by the rotational position detection means, such that the surface of the roller is irradiated at the same spots with the laser beam per rotation of the roller, the irradiation being performed a plurality of times, thereby forming the recesses in the surface of the roller.

7. The roller machining apparatus according to claim 6, further comprising:
pulse signal generation means for generating a pulse signal per rotation of the roller by a predetermined angle based on the detected position of the roller; and
pulse number setting means for setting the number of pulse signals to be generated per rotation of the roller based on pitches at which to form the recesses in the surface of the roller, wherein,
the control means controls the laser oscillator to count the number of pulse signals, and irradiate the surface of the roller with the laser beam each time the number reaches a number corresponding to the pitch.

8. The roller machining apparatus according to claim 6, wherein the material of the roller is cemented carbide, powder metallurgy high-speed steel, or tempered steel.

9. The roller machining apparatus according to claim 6, wherein the laser beam has a wavelength of 266 nm to 600 nm.
